(19) United States
(12) Patent Application Publication
(10) Pub. No.: US 2008/0151942 A1
(43) Pub. Date: Jun. 26, 2008

(54) Digital broadcasting system and method of processing data

(75) Inventors: Hyoung Gon Lee, Seoul (KR); In Hwan Choi, Gyeonggi-do (KR); Kook Yeon Kwak, Gyeonggi-do (KR); Jong Moon Kim, Gyeonggi-do (KR); Won Gyu Song, Seoul (KR); Byoung Gill Kim, Seoul (KR); Jin Woo Kim, Seoul (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG Electronics Inc.

(21) Appl. No.: 12/001,641

(22) Filed: Dec. 11, 2007

Related U.S. Application Data
(60) Provisional application No. 60/912,339, filed on Apr. 17, 2007.

(30) Foreign Application Priority Data
Dec. 11, 2006 (KR) 10-2006-0125799

(51) Int. Cl. H04J 3/06

(52) U.S. Cl. 370/510

(57) ABSTRACT

A digital broadcasting system and a method of processing data are disclosed. The method of processing data includes grouping a plurality of enhanced data packets, each having information included therein, thereby creating a data group, creating and indicating an identification signal in a predetermined position of at least one enhanced data packet within the data group, the identification signal designating insertion of a field synchronization signal within a data frame, multiplexing the enhanced data packet of the data group and a main data packet, thereby creating a data frame, and inserting a field synchronization signal within the data frame based upon the enhanced data packet having the identification signal indicated therein.

This application claims the benefit of the Korean Patent Application No. 10-2006-0125799, filed on Dec. 11, 2006, which is hereby incorporated by reference as if fully set forth herein. This application also claims the benefit of U.S. Provisional Application No. 60/912,339, filed on Apr. 17, 2007, which is hereby incorporated by reference.

### BACKGROUND OF THE INVENTION

1. Field of the Invention

The present invention relates to a digital broadcasting system, and more particularly, to a digital broadcasting system and a method of processing data that can receive and transmit (or process) digital broadcast signals.

2. Discussion of the Related Art

Presently, the technology for processing digital signals is being developed at a vast rate, and, as a larger number of the population uses the Internet, digital electric appliances, computers, and the Internet are being integrated. Furthermore, a user is now capable of viewing a digital broadcast program by using a portable or mobile receiver (or receiving system) while traveling between locations or at a fixed location. However, since a broadcast receiver, such as a fixed receiver and a portable receiver, receives digital broadcast signals through a wireless broadcast channel network, the receiving performance may be deteriorated when used in a poor channel environment. Particularly, the portable and mobile receivers require a greater level of robustness against frequent channel changes and noise.

### SUMMARY OF THE INVENTION

Accordingly, the present invention is directed to a digital broadcasting system and a method of processing data that substantially obviate one or more problems due to limitations and disadvantages of the related art.

An object of the present invention is to provide a digital broadcasting system and a method of processing data that are highly resistant to channel changes and noise.

Another object of the present invention is to provide a digital broadcasting system and a method of processing data that can perform additional encoding on enhanced data and transmitting the processed enhanced data, thereby enhancing the performance of the receiving system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of processing data in a transmitting system may include the steps of grouping a plurality of enhanced data packets, each having information included therein, thereby creating a data group, creating and indicating an identification signal in a predetermined position of at least one enhanced data packet within the data group, the identification signal designating insertion of a field synchronization signal within a data frame, multiplexing the enhanced data packet of the data group and a main data packet, thereby creating a data frame, and inserting a field synchronization signal within the data frame based upon the enhanced data packet having the identification signal indicated therein. Herein, the predetermined position of the enhanced data packet having the identification signal indicated therein may correspond to a position of a synchronization byte. And, the identification signal value may be different from a synchronization byte value.

In another aspect of the present invention, a transmitting system includes a group formatter, a packet formatter, a first multiplexer, and a second multiplexer. The group formatter groups a plurality of enhanced data packets, each having information included therein, thereby creating a data group. The packet formatter creates and indicates an identification signal in a predetermined position of at least one enhanced data packet within the data group, the identification signal designating insertion of a field synchronization signal within a data frame. The first multiplexer multiplexes the enhanced data packet of the data group and a main data packet, thereby creating a data frame. And, the second multiplexer inserts a field synchronization signal within the data frame based upon the enhanced data packet having the identification signal indicated therein.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a frame structure for transmitting enhanced data according to an embodiment of the present invention;

FIG. 2 illustrates an example of a data packet having an identification signal, which designates field synchronization signal insertion, indicated thereto according to an embodiment of the present invention;

FIG. 3 illustrates a block diagram of a transmitting system according to an embodiment of the present invention;

FIG. 4A and FIG. 4B respectively illustrate data structures prior to and after data deinterleaving process in the transmitting system according to the present invention;

FIG. 5A and FIG. 5B respectively illustrate partially expanded diagrams of FIG. 4A and FIG. 4B; and

FIG. 6 illustrates a block diagram of a receiving system according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meaning of each term lying within.

In the present invention, the enhanced data may either consist of data including information such as program execution files, stock information, weather forecast, and so on, or consist of video/audio data. Additionally, the known data refer to data already known based upon a pre-determined agreement between the transmitter and the receiver. Furthermore, the main data consist of data that can be received from the conventional receiving system, wherein the main data include video/audio data. Also, a data service using the enhanced data may include weather forecast services, traffic information services, stock information services, viewer participation quiz programs, real-time polls & surveys, interactive education broadcast programs, gaming services, services providing information on synopsis, character, background music, and filming sites of soap operas or series, services providing information on past match scores and player profiles and achievements, and services providing information on product information and programs classified by service, medium, time, and theme enabling purchase orders to be processed. Herein, the present invention is not limited only to the services mentioned above.

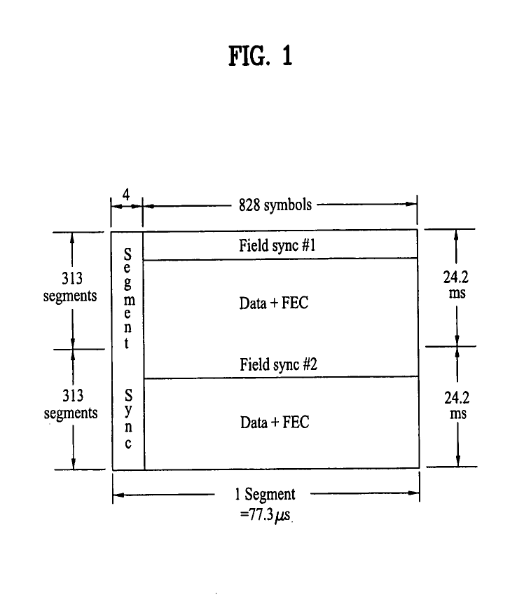

FIG. 1 illustrates a frame structure for transmitting enhanced data according to an embodiment of the present invention. Herein, one transmission frame is configured of an odd field and an even field. Each field is configured of one field synchronization segment and 312 data segments, and each segment is configured of 832 symbols. A segment synchronization pattern exists in the first 4 symbols of the field synchronization segment, which are then followed by pseudo random sequences PN 511, PN 63, PN 63, and PN 63. The next 24 symbols include information associated with the transmission mode. If the transmission mode corresponds to a vestigial side band (VSB) mode, VSB mode information is included in the 24 symbols. Herein, among the three PN 63 section, in the second PN 63 section, the sign (or polarity) is alternated in each field.

In other words, ‘+5’ becomes ‘−5’, and ‘−5’ becomes ‘+5’. Accordingly, depending upon the symbol of the second PN 63, a frame may be identified as either an odd field or an even field. For example, if all three PN 63 sections are identical to one another, the corresponding field is determined to be an odd field. Alternatively, if the second PN 63 of the three PN 63 sections is inversed, the corresponding field is determined to be an even field. Additionally, the 24 symbols that include information associated with the transmission mode are followed by the remaining 104 symbols, which are reserved symbols.

Meanwhile, a randomizer and a 12-way interleaver included in a trellis encoder should be reset at the point when the field synchronization segment is inserted in the data frame. In this case, when the receiving system (or receiver) receives the field synchronization signal, a derandomizer and a 12-way deinterleaver for a trellis-decoding process are initialized, thereby enabling the data to be recovered back to the initial state. Therefore, the present invention creates an identification signal indicating a position (or place) in which the field synchronization signal is to be inserted.

Accordingly, the present invention may refer to the identifications signal when inserting the field synchronization signal in the corresponding data frame.

For this, an example of indicating an identification signal designating the insertion of a field synchronization signal in a predetermined position of at least one data packet included in a data frame will be given as an embodiment of the present invention. At this point, in the proposed embodiment of the present invention, the identification signal is indicated in respective predetermined positions within each corresponding packet for each data packet cycle unit, with respect to the data being inputted so as to configure the data frame. For example, the identification signal may be indicated for each set of 312 data packets or for each set of 624 data packets. In case, the identification signal is indicated for each set of 312 data packets, the identification signal may respectively designate the position of an odd field synchronization signal and an even field synchronization signal. In this case, the identification signal values of both fields may be equal to one another or different from one another.

The data packet may correspond to a main data packet or to an enhanced data packet. A position of a segment synchronization byte of a header included in the data packet may be presented as an example of the predetermined position (or place) in this embodiment of the present invention. In this case, the identification signal value may indicate a value pre-decided according to an agreement between the receiving system and the transmitting system. For example, the synchronization byte value may be modified and used as the identification signal value. In other words, the synchronization byte value may be inversed for each bit so as to be used as the identification signals. Alternatively, only some of the synchronization byte values may be inversed so as to be used as the identification signals. Any value that can designate insertion of the field synchronization signal may be used as the identification signal value. Therefore, the present invention is not limited to the example presented in this embodiment.

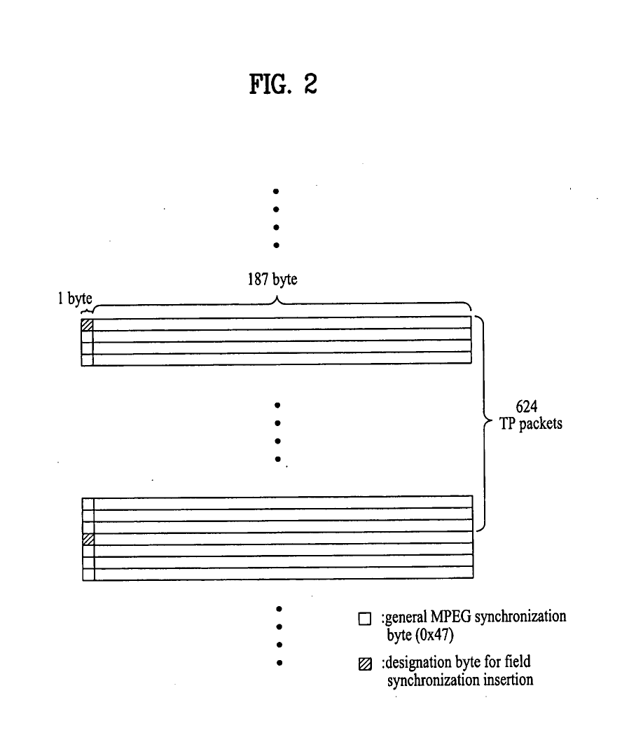

FIG. 2 illustrates an example of indicating an identification signal designating the insertion of a field synchronization signal in the position of a segment synchronization byte of a corresponding data packet at intervals of 624 data packets. Referring to FIG. 2, if the identification signal designating the insertion of the field synchronization signal is indicated for each set of 624 packets, either an odd field synchronization segment or an even field synchronization segment may be set to be inserted based upon the identification signal. For example, if the odd field synchronization segment is set to be inserted, the even field synchronization segment may be set to be inserted after 312 data segments following the odd field synchronization segment.

Additionally, in this embodiment of the present invention, when the main data and the enhanced data are multiplexed and transmitted, the present invention groups a plurality of consecutive enhanced data packets so as to form a data group. Thereafter, a plurality of data groups and main data are mixed so as to form a burst. In this case, enhanced data and main data co-exist in the same burst section, and only the main data exist in non-burst sections. At this point, a data group is configured to include the field synchronization signal. A detailed example of the enhanced data packet having an identification signal indicated therein, wherein the identification signal designates the insertion of the field synchronization signal, will be described in a later process.

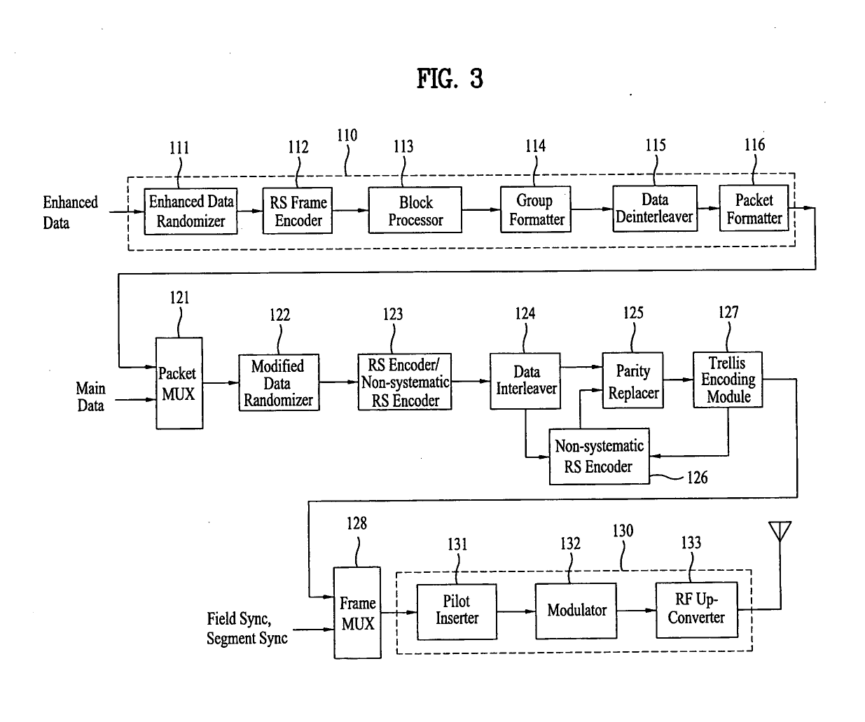

FIG. 3 illustrates a block diagram of a transmitting system (or transmitter) adopting the identification signal designating the insertion of the field synchronization signal according to an embodiment of the present invention. Herein, the transmitting system according to the present invention is merely exemplary. Therefore, the present invention may be applied to any transmitting system that inserts a field synchronization signal. Referring to FIG. 3, the transmitting system includes a pre-processor 110, a packet multiplexer 121, a data randomizer 122, a RS encoder/non-systematic RS encoder 123, a data interleaver 124, a parity replacer 125, a non-systematic RS encoder 126, a trellis-encoding module 127, a frame multiplexer 128, and a transmitting unit 130. The pre-processor 110 includes an enhanced data randomizer 111, a RS frame encoder 112, a block processor 113, a group formatter 114, a data deinterleaver 115, and a packet formatter 116. In the above-described structure of the present invention, the main data are inputted to the packet multiplexer 121, and the enhanced data are inputted to the enhanced data randomizer 111 of the pre-processor 110, which performs additional encoding so that the enhanced data can respond more effectively to noise and channel environment that undergoes frequent changes.

The enhanced data randomizer 111 receives enhanced data and randomizes the received data, thereby outputting the processed enhanced data to the RS frame encoder 112. At this point, by having the enhanced data randomizer 111 randomize the enhanced data, a later randomizing process on the enhanced data performed by a data randomizer 122, which is positioned in a later block, may be omitted. The randomizer of the conventional system may be identically used as the randomizer for randomizing the enhanced data. Alternatively, any other type of randomizer may also be used for this process.

The RS frame encoder 112 performs at least one of an error correction encoding process and an error detection encoding process on the inputted randomized enhanced data so as to provide robustness on the corresponding enhanced data. Thus, by providing robustness on the enhanced data, a group error that may occur due to a change in the frequency environment can be scattered, thereby enabling the corresponding data to respond to the severely vulnerable and frequently changing frequency environment. The RS frame encoder 112 may also include a row permutation process, which permutes enhanced data having a predetermined size in row units.

In this embodiment of the present invention, the RS frame encoder 112 performs error correction encoding on the inputted enhanced data so as to add the data required for the error correction process. Then, the RS frame encoder 112 performs error detection encoding on the process enhanced data so as to add the data required for the error detection process. Herein, RS encoding is applied as the error correction encoding process, and cyclic redundancy check (CRC) encoding is applied as the error detection encoding process. When performing RS encoding, parity data that are to be used for error correction are generated. And, when performing CRC encoding, CRC data that are to be used for error detection are generated.

In this embodiment of the present invention, the RS encoding will be adopting a forward error correction (FEC) method. The FEC corresponds to a technique for compensating errors that occur during the transmission process. The CRC data generated by CRC encoding may be used for indicating whether or not the enhanced data have been damaged by the errors while being transmitted through the channel. In the present invention, a variety of error detection coding methods other than the CRC encoding method may be used, or the error correction coding method may be used to enhance the overall error correction ability of the receiving system.

As described above, the enhanced data encoded by the RS frame encoder 112 are inputted to the block processor 113. The block processor 113 then encodes the inputted enhanced data at a coding rate of G/H (wherein, G is smaller than H (i.e., G<H)) and then outputted to the group formatter 114. More specifically, the block processor 113 divides the enhanced data being inputted in byte units into bit units. Then, the G number of bit is encoded to H number of bit. Thereafter, the encoded bits are converted back to byte units and then outputted. For example, if 1 bit of the input data is coded to 2 bits and outputted, then G is equal to 1 and H is equal to 2 (i.e., G=1 and H=2). Alternatively, if 1 bit of the input data is coded to 4 bits and outputted, then G is equal to 1 and H is equal to 4 (i.e., G=1 and H=4). Hereinafter, the former coding rate will be referred to as a coding rate of ½ (½-rate coding), and the latter coding rate will be referred to as a coding rate of ¼ (¼-rate coding), for simplicity.

Herein, when using the ¼ coding rate, the coding efficiency is greater than when using the ½ coding rate, and may, therefore, provide greater and enhanced error correction ability. For such reason, when it is assumed that the data encoded at a ¼ coding rate in the group formatter 114, which is located near the end portion of the system, are allocated to an area in which the receiving performance may be deteriorated, and that the data encoded at a ½ coding rate are allocated to an area having excellent receiving performance, the difference in performance may be reduced.

At this point, the block processor 113 may also receive additional information data, such as signaling information including system information. Herein, the additional information data may also be processed with either ½-rate coding or ¼-rate coding as in the step of processing the enhance data. Thereafter, additional information data, such as signaling information, is also considered the same as the enhanced data and processed accordingly. The signaling information is information required that a receiving system receives and processes data included in a data group. The signaling information may include data group information, multiplexing information, burst information, and so on.

Meanwhile, the group formatter 114 inserts enhanced data that are outputted from the block processor 113 in corresponding areas within a data group, which is configured in accordance with a pre-defined rule. Also, with respect to the data deinterleaving process, each place holder or known data are inserted in corresponding areas within the data group. At this point, the data group may be divided into at least one hierarchical area. Herein, the type of enhanced data being allocated to each area may vary depending upon the characteristics of each hierarchical area.

Furthermore, a data group is configured to include field synchronization data. Accordingly, during the channel equalization process, the receiving system (or receiver) may use not only the known data but also the channel information obtained from the field synchronization data so as to perform the equalization process. Thus, a robust equalization performance may be obtained.

According to an embodiment of the present invention, a data group is configured to have the data within the data group to be allocated to 118 data segments based upon the data prior to being data-interleaved.

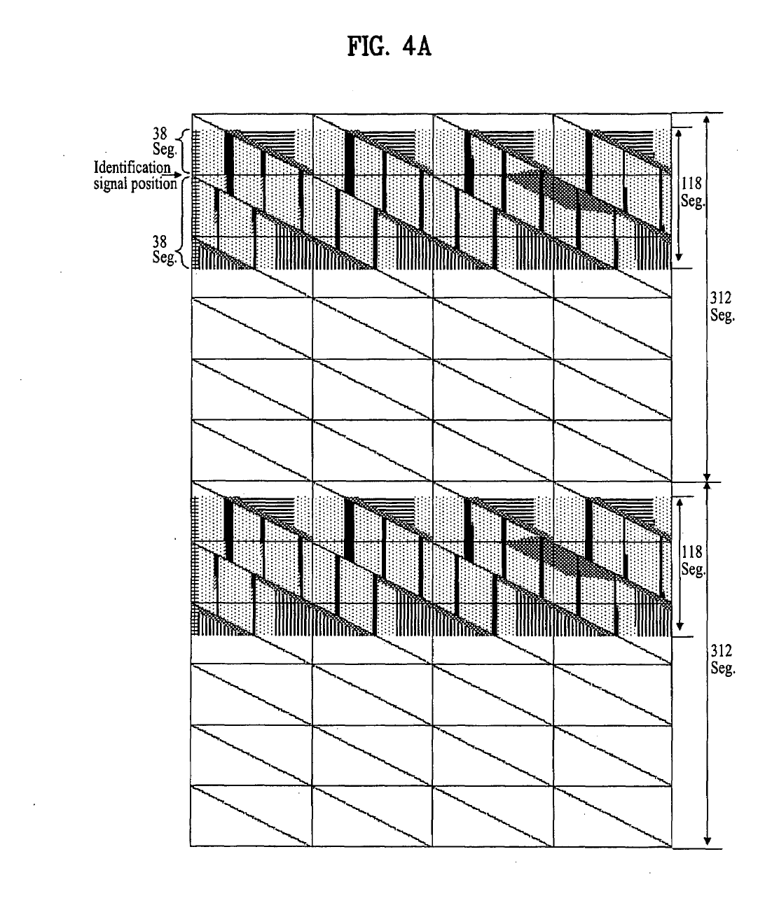

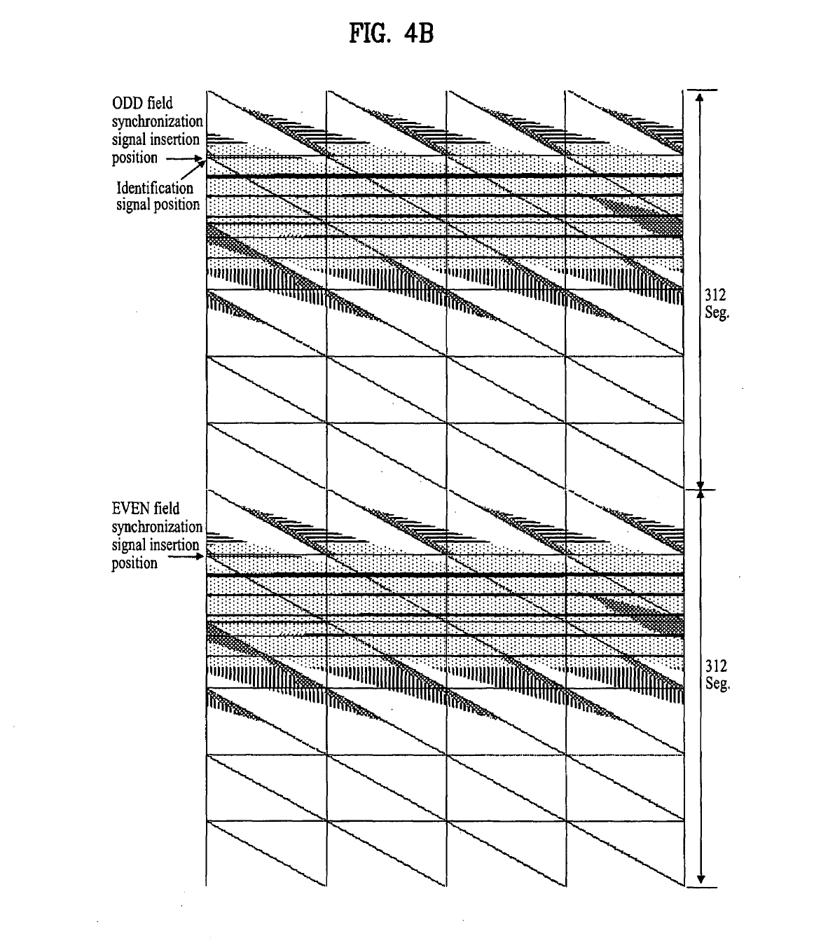

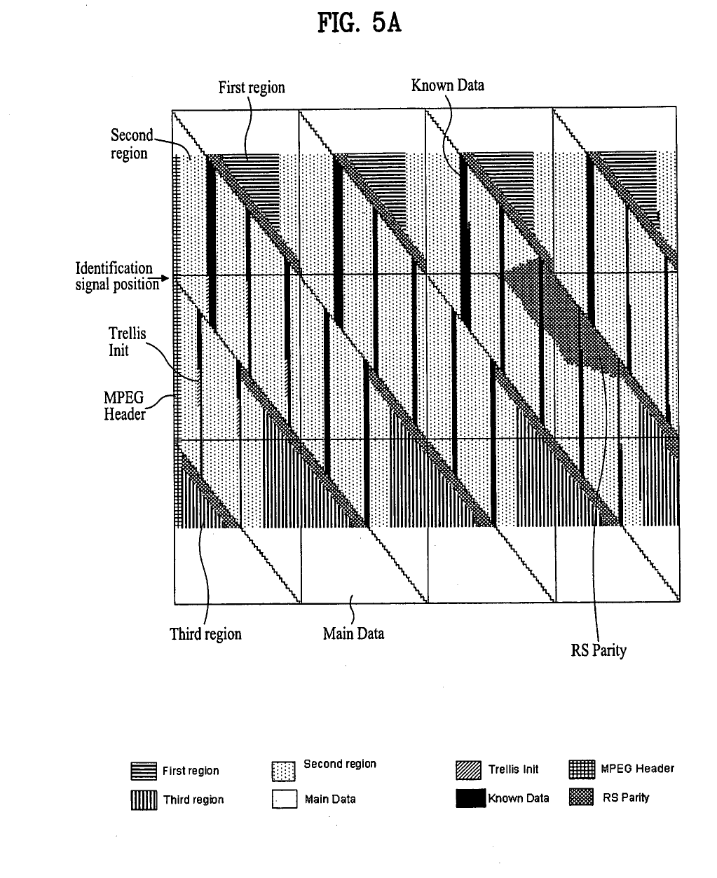

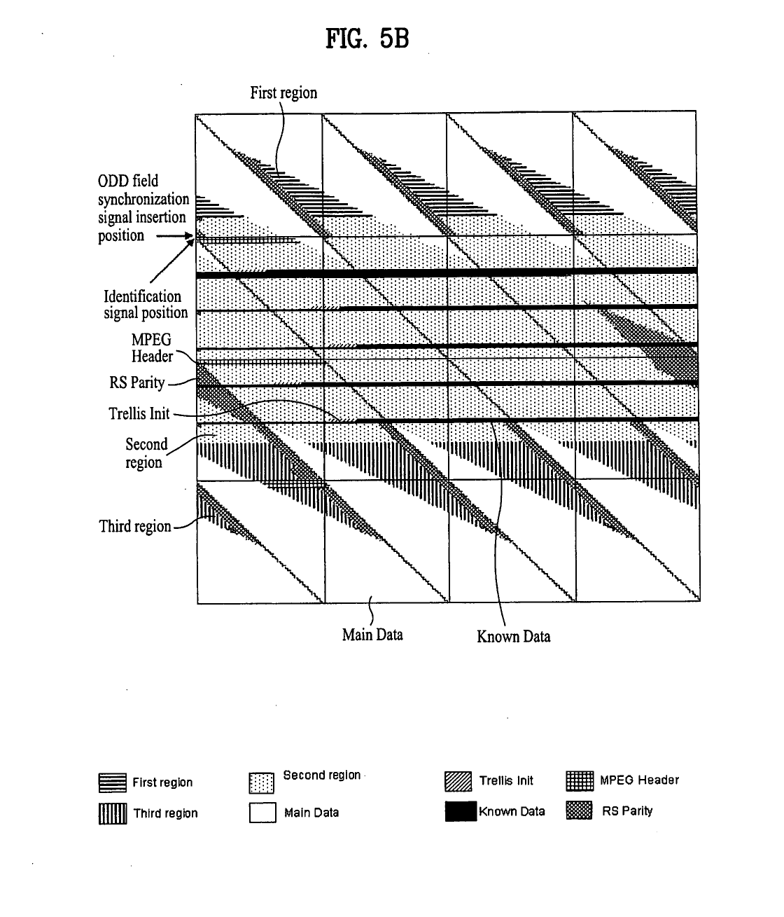

FIG. 4A illustrates an alignment of data prior to being data-interleaved. FIG. 4B illustrates an alignment of data after being data-interleaved. FIG. 5A illustrates an enlargement of a 52*3 segment portion including the beginning of the data group shown in FIG. 4A. And, FIG. 5B illustrates an enlargement of a 52*4 segment portion including the beginning of the data group shown in FIG. 4B. In a transmitting system using a general VSB mode, a single transport packet is interleaved by a data-interleaving process so as to be scattered and outputted by a plurality of data segments. However, since a 207-byte packet has the same amount of data as a single data segment, a data packet prior to being data-interleaved may also be used as a data segment.

FIG. 4A and FIG. 5A each illustrates the example of 118 segments being allocated to a single data group within 312 segments configuring a single field. The 118 segments of the one data group include 38 segments before the position to which field synchronization data are to be inserted and 80 segments behind the position to which field synchronization data are to be inserted. In this case, the identification signal designating the insertion of field synchronization signals (or data) may be indicated in at least one of the 118 segments (or packets) included in the data group.

According to an embodiment of the present invention, based upon the position to which the field synchronization data are to be inserted, the identification signal is either indicated on the first segment before the position for inserting field synchronization data. Alternatively, the identification signal is indicated on the first segment after the position for inserting field synchronization data. The indication of the identification signal is performed in a later block (e.g., the packet formatter). A detailed description of this process will be described later on. When it is assumed that the identification signal is indicated on a 39^{th} segment within a data group, as shown in FIG. 4A, the frame multiplexer 128 may insert a field synchronization segment in a corresponding data frame, based upon the point where the segment including the identification signal is being inputted. Furthermore, based upon the data packet including the identification signal, the packet multiplexer 121 may also multiplex the main data and the enhanced data.

FIG. 4B and FIG. 5B illustrate the structure of data after being data-interleaved, which actually corresponds to a data structure configuring a data frame. According to this embodiment of the present invention, FIG. 4B and FIG. 5B illustrate examples of dividing a single data group into three different regions 211 to 213, based upon the data structure after data interleaving. Herein, each of the three regions may be respectively referred to as a first region, a second region, and a third region, for simplicity. For example, the data group may be divided into the first to third regions based upon the receiving performance of each region.

Herein, the data group is divided into a plurality of different regions so that each region can be used for different purposes. More specifically, a region having less or no interference from the main data may provide a more enhanced (or powerful) receiving performance as compared to a region having relatively more interference from the main data. Furthermore, when using a system inserting and transmitting known data into the data group, and when a long known data sequence is to be consecutively inserted into the enhanced data, a known data sequence having a predetermined length may be consecutively inserted into a region having no interference from the main data. Conversely, in case of the regions having interference from the main data, it is difficult to consecutively insert long known data sequences into the corresponding regions due to the interference from the main data. In the description of the present invention, the size of the data group, the number of hierarchically divided regions within the data group, the size of each hierarchically divided region, the number of enhanced data bytes that may be inserted into each of the hierarchically divided regions correspond to an exemplary embodiment of the present invention.

More specifically, with respect to the data that have been processed with data-interleaving, the first region 211 may correspond to a region, wherein a long known data sequence is consecutively inserted into the data group. Herein, the first region 211 may also include a region that is not mixed with main data. The second region 212 may be allocated to the remaining portion of the data group in front of (or prior to) the first region 211. And, the third region 213 may be allocated to the remaining portion of the data group behind (or subsequent to) the first region 213. In the present invention, different coding rates may be applied to regions which are expected to show different performance after being equalized by the channel information that may be used for channel equalization in the receiving system.

For example, the enhanced data that are to be inserted to the first region 211 may be encoded at a ½-coding rate by the block processor 113. Then, the ½-rate coded enhanced data are inserted to the first region 211 by the group formatter 114. Additionally, the enhanced data that are to be inserted to the second region 212 and the third region 213 may be respectively encoded at a ¼-coding rate by the block processor 113. Herein, the ¼-coding rate provides greater error correction performance than the ½-coding rate. Thereafter, the ¼-rate coded enhanced data are respectively inserted to the second and third regions 212 and 213 by the group formatter 114. Furthermore, apart from the enhanced data, the group formatter 114 also inserts additional information data in the data group. Herein, such additional information data may include signaling information, which notifies overall transmission information.

Meanwhile, apart from the enhanced data encoded and outputted from the block processor 113, the group formatter 114 also inserts the MPEG header place holders, non-systematic RS parity place holders, and main data place holders with respect to data deinterleaving in a later process, as shown in FIG. 4B and FIG. 5B. Herein, the main data place holders are inserted because of the presence of a region in which enhanced data are mixed with main data, based upon the data being interleaved. For example, a data place holder for the MPEG header is allocated to the very beginning of each packet with respect to the output data that have been data-deinterleaved. Furthermore, the group formatter 114 inserts known data generated in accordance with a pre-decided method or inserts known data place holders for inserting known data in a later process. The group formatter 114 also inserts place holders for the initialization of the trellis encoding module 127 in the corresponding regions. For example, the initialization data place holder may be inserted at the beginning of the known data sequence. At this point, the size of the enhanced data that can be inserted in a data group may vary depending upon the sizes of the trellis initialization data or known data, the MPEG header, and the RS parity byte, which are also inserted in the corresponding data group.

The output of the group formatter 114 is inputted to the data deinterleaver 115. The data deinterleaver 115 deinterleaves the data and data place holders within the data group being outputted from the group formatter 114 as an inverse process of the data interleaving process. The packet formatter 116 removes the main data place holders and the RS parity place holders from the inputted deinterleaved data, the main data place holders and the RS parity place holders having been allocated earlier for the deinterleaving process. Then, the packet formatter 116 groups the remaining portion and inserts a MPEG header in the 4-byte MPEG header place holder. At this point, the packet formatter 116 may generate an identification signal designating insertion of a field synchronization signal to a predetermined position of at least one packet within the data group being inputted. Then, the packet formatter 116 may indicate the generated identification signal.

In the embodiment of the present invention, an identification signal for designating the insertion of a field synchronization signal into a position of a segment synchronization byte within a MPEG header of a 39^{th} enhanced data packet included in the data group is generated and indicated. At this point, the identification signal may be indicated at a segment synchronization byte position of the corresponding enhanced data packet for each data group. In this case, the identification signal may be indicated in the insertion position of an odd field synchronization signal and an even field synchronization signal, respectively. Furthermore, the identification signal may be indicated in a segment synchronization byte position of the corresponding enhanced data packet for each (2N−1)^{th} data group and 2N^{th} data group (wherein N is an integer), i.e., for each two data groups. In this case, the identification signal may either designate the insertion position of an odd field synchronization signal or designate the insertion position of an even field synchronization signal. Accordingly, the insertion position of the field synchronization signal that has not been designated may be deduced by counting the number of packets having identification signals included therein.

In the embodiment of the present invention, the identification signal value may be differentiated from the segment synchronization byte value. For example, a value having absolutely no relevance with the synchronization byte value may be used as the identification signal value. Alternatively, the synchronization byte values may all be inversed for each bit, so as to be used as the corresponding identification signal values. Furthermore, only some of the synchronization byte values may be inversed, so as to be used as the corresponding identification signal values. Herein, any value that can be able to designate the insertion of a field synchronization signal may be used as the identification signal value. The present invention is, therefore, not limited only to the examples presented in the description of the present invention. It is assumed that the synchronization byte value is equal to ‘0x47’, and when the synchronization byte values are all inversed for each bit, the packet formatter 114 generates a value of ‘0xB8’ as the identification signal value. Then, the generated value of ‘0xB8’ is indicated to the synchronization byte position of the corresponding enhanced data packet.

Also, when the group formatter 114 inserts known data place holders, the packet formatter 115 may insert actual known data in the known data place holders, or may directly output the known data place holders without any modification in order to make replacement insertion in a later process.

Thereafter, the packet formatter 116 identifies the data within the packet-formatted data group, as described above, as a 188-byte unit enhanced data packet (i.e., MPEG TS packet), which is then provided to the packet multiplexer 121. The packet multiplexer 121 multiplexes the 188-byte unit enhanced data packet and main data packet outputted from the packet formatter 116 in accordance with a pre-defined multiplexing method. Then, the packet multiplexer 121 outputs the multiplexed enhanced data packet to the data randomizer 122. Herein, the multiplexing method may be adjusted in accordance with a plurality of variables related with the system design.

One of the multiplexing methods of the packet multiplexer 121 may correspond to identifying enhanced data burst sections and main data sections along a time axis and alternately repeating the two sections. At this point, the enhanced data burst section may transmit at least one data group (e.g., 18 data groups), and the main data section may only transmit main data. The enhanced data burst section may also transmit the main data. When the enhanced data are transmitted in a burst structure, as described above, a receiving system receiving only the enhanced data may turn on the power only during the burst section so as to receive the data. And, during the main data section to which only main data are transmitted, the digital broadcast receiving system may turn the power off so that the main data are not received, thereby reducing power consumption of the receiving system.

When the data being inputted correspond to the main data packet, the data randomizer 122 performs the same randomizing process of the conventional randomizer. More specifically, the synchronization byte included in the main data packet is discarded and a pseudo random byte generated from the remaining 187 byte is used so as to randomize the data. Thereafter, the randomized data are outputted to the RS encoder/non-systematic RS encoder 123. However, when the inputted data correspond to the enhanced data packet, the synchronization byte of the 4-byte MPEG header included in the enhanced data packet is discarded, and data randomizing is performed only on the remaining 3-byte MPEG header. Data randomizing is not performed on the remaining portion of the enhanced data. Instead, the remaining portion of the enhanced data is outputted to the RS encoder/non-systematic RS encoder 123. This is because the randomizing process has already been performed on the enhanced data by the enhanced data randomizer 111 in an earlier process. Herein, a data randomizing process may or may not be performed on the known data (or known data place holder) and the initialization data place holder included in the enhanced data packet.

If an enhanced data packet having an identification signal is included in the data group that is being inputted to the data randomizer 122, the position of the synchronization byte of the corresponding enhanced data packet is indicated with an identification signal value. Therefore, when the synchronization byte is discarded during the randomizing process, the enhanced data packet information having the identification signal value indicated therein should be transmitted to a block that requires the synchronization signal (e.g., the frame multiplexer). The enhanced data packet information having the identification signal value indicated therein may be transferred by using various methods. For example, the enhanced data packet information may be included in attribute information so as to be transmitted to the corresponding block.

In the embodiment of the present invention, when the synchronization byte is being discarded, the process of transferring the enhanced data packet information having the identification signal value indicated therein is performed by the data randomizer 122. However, according to another embodiment of the present invention, the same process may be performed by the packet multiplexer 121. Furthermore, during the process of generating the identification signal and indicating the generated identification signal to the corresponding data packet, when a null data packet corresponding to the data packet is being inputted to the packet multiplexer 121 instead of the packet formatter 116, the identification signal may be indicated in a position of the synchronization byte within the corresponding null data byte. In this case, the packet multiplexer 121 selects and outputs the enhanced data packet of the data group, which is being outputted from the packet formatter 116, instead of the null data packet. At this point, data packet information including the identification signal may also be transmitted along with the selected enhanced data packet.

The RS encoder/non-systematic RS encoder 123 RS-codes the data randomized by the data randomizer 122 or the data bypassing the data randomizer 122. Then, the RS encoder/non-systematic RS encoder 123 adds a 20-byte RS parity to the coded data, thereby outputting the RS-parity-added data to the data interleaver 124. At this point, if the inputted data correspond to the main data packet, the RS encoder/non-systematic RS encoder 123 performs a systematic RS-coding process identical to that of the conventional broadcasting system on the inputted data, thereby adding the 20-byte RS parity at the end of the 187-byte data. Alternatively, if the inputted data correspond to the enhanced data packet, the 20 bytes of RS parity gained by performing the non-systematic RS-coding are respectively inserted in the decided parity byte places (or positions) within the enhanced data packet. Herein, the data interleaver 124 corresponds to a byte unit convolutional interleaver. The output of the data interleaver 124 is inputted to the parity byte replacer 125 and the non-systematic RS encoder 126.

Meanwhile, a memory within the trellis encoding module 127, which is positioned after the parity byte replacer 125, should first be initialized in order to allow the output data of the trellis encoding module 127 so as to become the known data defined based upon an agreement between the receiving system and the transmitting system. More specifically, the memory of the trellis encoding module 127 should first be initialized before the known data sequence being inputted is trellis-encoded. At this point, it is assumed that the beginning of the known data sequence that is inputted corresponds to the initialization data place holder inserted by the group formatter 114 and not the actual known data. Therefore, a process of generating initialization data immediately before the trellis-encoding of the known data sequence being inputted and a process of replacing the initialization data place holder of the corresponding trellis encoding module memory with the newly generated initialization data are required.

A value of the trellis memory initialization data is decided based upon the memory status of the trellis encoding module 127, thereby generating the trellis memory initialization data accordingly. Due to the influence of the replace initialization data, a process of recalculating the RS parity, thereby replacing the RS parity outputted from the trellis encoding module 127 with the newly calculated RS parity is required. Accordingly, the non-systematic RS encoder 126 receives the enhanced data packet including the initialization data place holder that is to be replaced with the initialization data from the data interleaver 124 and also receives the initialization data from the trellis encoding module 127. Thereafter, among the received enhanced data packet, the initialization data place holder is replaced with the initialization data. Subsequently, the RS parity data added to the enhanced data packet is removed. Then, a new non-systematic RS parity is calculated and outputted to the parity byte replacer 125. Accordingly, the parity byte replacer 125 selects the output of the data interleaver 124 as the data within the enhanced data packet, and selects the output of the non-systematic RS encoder 126 as the RS parity. Thereafter, the parity byte replacer 125 outputs the selected data.

Meanwhile, if the main data packet is inputted, or if the enhanced data packet that does not include the initialization data place holder that is to be replaced, the parity byte replacer 125 selects the data and RS parity outputted from the data interleaver 124 and directly outputs the selected data to the trellis encoding module 127 without modification. The trellis encoding module 127 converts the byte-unit data to symbol-unit data and 12-way interleaves and trellis-encodes the converted data, which are then outputted to the frame multiplexer 128. The frame multiplexer 128 inserts segment synchronization signals in each data packet being outputted from the trellis encoding module 127. Also, once it is verified that the inputted data packet corresponds to the data packet including identification signals, the frame multiplexer 128 inserts field synchronization signals based upon the data packet. Then, the processed data are outputted to a transmitting unit 130.

At this point, the data randomizer 122 and the trellis encoding module 127 both have knowledge of the data packet information including the identification signal. Therefore, the data randomizer 122 and the trellis encoding module 127 are both reset in accordance with the point when the field synchronization signals are being inserted. Herein, the transmitting unit 130 includes a pilot inserter 131, a modulator 132, and a radio frequency (RF) up-converter 133. The operation of the transmitting unit 130 is identical to the conventional transmitters. Therefore, a detailed description of the same will be omitted for simplicity.

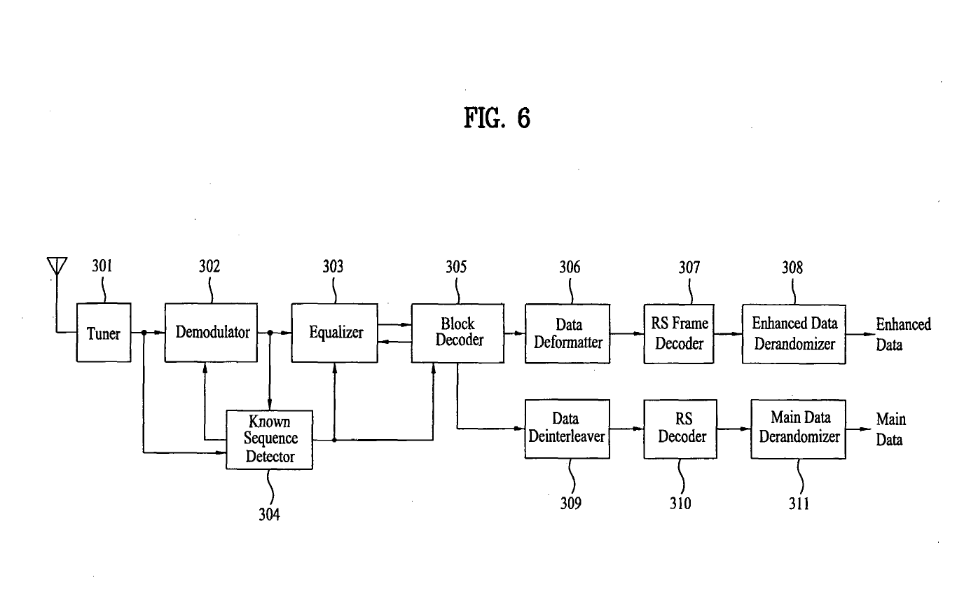

FIG. 6 illustrates a block diagram showing a structure of a receiving system according to the present invention. The receiving system of FIG. 6 uses known data information, which is inserted in the enhanced data section and, then, transmitted by the transmitting system, so as to perform carrier recovery, timing recovery, frame synchronization recovery, and channel equalization, thereby enhancing the receiving performance. The receiving system may also perform frame synchronization recovery based upon the identification signal included in a predetermined position of at least one enhanced data packet within a data group. The identification signal designates position of a field synchronization signal within a data frame.

Referring to FIG. 6, the digital broadcast receiving system includes a tuner 301, a demodulator 302, an equalizer 303, a known sequence detector 304, a block decoder 305, a data deformatter 306, a RS frame decoder 307, an enhanced data derandomizer 308, a data deinterleaver 309, a RS decoder 310, and a main data derandomizer 311. Herein, for simplicity of the description of the present invention, the data deformatter 306, the RS frame decoder 307, and the enhanced data derandomizer 308 will be collectively referred to as an enhanced data processing unit. And, the data deinterleaver 309, the RS decoder 310, and the main data derandomizer 311 will be collectively referred to as a main data processing unit.

More specifically, the tuner 301 tunes a frequency of a particular channel and down-converts the tuned frequency to an intermediate frequency (IF) signal. Then, the tuner 301 outputs the down-converted IF signal to the demodulator 302 and the known sequence detector 304. The demodulator 302 performs self gain control, carrier recovery, and timing recovery processes on the inputted IF signal, thereby modifying the IF signal to a baseband signal. Then, the demodulator 302 outputs the newly created baseband signal to the equalizer 303 and the known sequence detector 304. The equalizer 303 compensates the distortion of the channel included in the demodulated signal and then outputs the error-compensated signal to the block decoder 305.

At this point, the known sequence detector 304 detects the known sequence place inserted by the transmitting end (or system) from the input/output data of the demodulator 302 (i.e., the data prior to the demodulation process or the data after the demodulation process). Thereafter, the place (or position) information along with the symbol sequence of the known data, which are generated from the detected place (or position), is outputted to the demodulator 302 and the equalizer 303. Also, the known sequence detector 304 outputs a set of information to the block decoder 305. This set of information is used to allow the block decoder 305 of the receiving system to identify the enhanced data that are processed with additional encoding from the transmitting system and the main data that are not processed with additional encoding. In addition, although the connection status is not shown in FIG. 6, the information detected from the known sequence detector 304 may be used throughout the entire receiving system and may also be used in the data deformatter 306 and the RS frame decoder 307. The demodulator 302 uses the known data symbol sequence during the timing and/or carrier recovery, thereby enhancing the demodulating performance. Similarly, the equalizer 303 uses the known data so as to enhance the equalizing performance. Moreover, the decoding result of the block decoder 305 may be fed-back to the equalizer 303, thereby enhancing the equalizing performance.

The equalizer 303 may perform channel equalization by using a plurality of methods. An example of estimating a channel impulse response (CIR) so as to perform channel equalization will be given in the description of the present invention. Most particularly, an example of estimating the CIR in accordance with each region within the data group, which is hierarchically divided and transmitted from the transmitting system, and applying each CIR differently will also be described herein. Furthermore, by using the known data, the place and contents of which is known in accordance with an agreement between the transmitting system and the receiving system, and the field synchronization data, so as to estimate the CIR, the present invention may be able to perform channel equalization with more stability. Herein, according to an embodiment of the present invention, a data group that is being inputted for equalization is divided into first to third regions, as shown in FIG. 4B and FIG. 5B.

As described above, the present invention uses the CIR estimated from the field synchronization data and the known data sequences in order to perform channel equalization on data within the data group. At this point, each of the estimated CIRs may be directly used in accordance with the characteristics of each region within the data group. Alternatively, a plurality of the estimated CIRs may also be either interpolated or extrapolated so as to create a new CIR, which is then used for the channel equalization process.

Herein, when a value F(A) of a function F(x) at a particular point A and a value F(B) of the function F(x) at another particular point B are known, interpolation refers to estimating a function value of a point within the section between points A and B. Linear interpolation corresponds to the simplest form among a wide range of interpolation operations. The linear interpolation described herein is merely exemplary among a wide range of possible interpolation methods. And, therefore, the present invention is not limited only to the examples set forth herein.

Alternatively, when a value F(A) of a function F(x) at a particular point A and a value F(B) of the function F(x) at another particular point B are known, extrapolation refers to estimating a function value of a point outside of the section between points A and B. Linear extrapolation is the simplest form among a wide range of extrapolation operations. Similarly, the linear extrapolation described herein is merely exemplary among a wide range of possible extrapolation methods. And, therefore, the present invention is not limited only to the examples set forth herein.

Meanwhile, if the data being inputted to the block decoder 305 after being channel equalized from the equalizer 303 correspond to the enhanced data having additional encoding and trellis-encoding performed thereon by the transmitting system, trellis-decoding and additional decoding processes are performed on the inputted data as inverse processes of the transmitting system. Alternatively, if the data being inputted to the block decoder 305 correspond to the main data having only trellis-encoding performed thereon, and not the additional encoding, only the trellis-decoding process is performed on the inputted data as the inverse process of the transmitting system. The data group decoded by the block decoder 305 is inputted to the data deformatter 306, and the main data packet is inputted to the data deinterleaver 309.

More specifically, if the inputted data correspond to the main data, the block decoder 305 performs Viterbi decoding on the inputted data so as to output a hard decision value or to perform a hard-decision on a soft decision value, thereby outputting the result. Meanwhile, if the inputted data correspond to the enhanced data, the block decoder 305 outputs a hard decision value or a soft decision value with respect to the inputted enhanced data. In other words, if the inputted data correspond to the enhanced data, the block decoder 305 performs a decoding process on the data encoded by the block processor and trellis encoding module of the transmitting system.

At this point, the RS frame encoder of the pre-processor included in the transmitting system may be viewed as an external code. And, the block processor and the trellis encoder may be viewed as an internal code. In order to maximize the performance of the external code when decoding such concatenated codes, the decoder of the internal code should output a soft decision value. Therefore, the block decoder 305 may output a hard decision value on the enhanced data. However, when required, it may be more advantageous for the block decoder 305 to output a soft decision value.

Meanwhile, the data deinterleaver 309, the RS decoder 310, and the main data derandomizer 311 are blocks required for receiving the main data. Therefore, the above-mentioned blocks may be omitted from the structure of a receiving system that only receives the enhanced data. The data deinterleaver 309 performs an inverse process of the data interleaver included in the transmitting system. In other words, the data deinterleaver 309 deinterleaves the main data outputted from the block decoder 305 and outputs the deinterleaved main data to the RS decoder 310. The RS decoder 310 performs a systematic RS decoding process on the deinterleaved data and outputs the processed data to the main data derandomizer 311. The main data derandomizer 311 receives the output of the RS decoder 310 and generates a pseudo random data byte identical to that of the randomizer included in the digital broadcast transmitting system. Thereafter, the main data derandomizer 311 performs a bitwise exclusive OR (XOR) operation on the generated pseudo random data byte, thereby inserting the MPEG synchronization bytes to the beginning of each packet so as to output the data in 188-byte main data packet units.

Meanwhile, the data being outputted from the block decoder 305 to the data deformatter 306 are inputted in the form of a data group. At this point, the data deformatter 306 is already informed of the structure of the data that are to be inputted and is, therefore, capable of identifying the signaling information, which includes the system information, as well as the enhanced data from the data group. Thereafter, the data deformatter 306 outputs the identified signaling information to a block associated with the system information and outputs the identified enhanced data to the RS frame decoder 307. At this point, the data deformatter 306 removes the main data, trellis initialization data, and MPEG header, which were inserted in the main data and data group, and also removes the RS parity, which was added by the RS encoder/non-systematic RS encoder or non-systematic RS encoder of the transmitting system, from the corresponding data. Thereafter, the process data are outputted to the RS frame decoder 307.

More specifically, the RS frame decoder 307 receives only the RS-coded and CRC-coded enhanced data that are transmitted from the data deformatter 306. The RS frame encoder 307 performs an inverse process of the RS frame encoder included in the transmitting system so as to correct the error within the RS frame. Then, the RS frame decoder 307 adds the 1-byte MPEG synchronization service data packet, which had been removed during the RS frame encoding process, to the error-corrected enhanced data packet. Thereafter, the processed data packet is outputted to the enhanced data derandomizer 308. The enhanced data derandomizer 308 performs a derandomizing process, which corresponds to the inverse process of the randomizer included in the transmitting system, on the received enhanced data. Thereafter, the derandomized data are outputted, thereby obtaining the enhanced data transmitted from the transmitting system.

As described above, the present invention has the following advantages. More specifically, the present invention is highly protected against (or resistant to) any error that may occur when transmitting enhanced data through a channel. And, the present invention is also highly compatible to the conventional receiving system. Moreover, the present invention may also receive the enhanced data without any error even in channels having severe ghost effect and noise.

Additionally, by generating identification signals, which designate the insertion of field synchronization signals, and by indicating the generated identification signals on predetermined positions (or places) of a corresponding data packet, a randomizer and an interleaver within a trellis encoding module may be accurately reset at the point of the insertion of the field synchronization signals. Accordingly, when the receiving system also receives the field synchronization signals, a derandomizer and a deinterleaver for a trellis-decoding process are initialized, thereby enabling the data to be recovered normally back to the initial state.

Furthermore, the present invention is even more effective when applied to mobile and portable receivers, which are also liable to a frequent change in channel and which require protection (or resistance) against intense noise.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of processing data in a transmitting system, the method comprising:
grouping a plurality of enhanced data packets, each having information included therein, thereby creating a data group;
creating and indicating an identification signal in a predetermined position of at least one enhanced data packet within the data group, the identification signal designating insertion of a field synchronization signal within a data frame;
multiplexing the enhanced data packet of the data group and a main data packet, thereby creating a data frame; and
inserting a field synchronization signal within the data frame based upon the enhanced data packet having the identification signal indicated therein.

2. The method of claim 1, wherein the predetermined position of the enhanced data packet having the identification signal indicated therein corresponds to a position of a synchronization byte.

3. The method of claim 2, wherein the identification signal value is different from a synchronization byte value.

4. The method of claim 2, wherein the identification signal value is an inversed value of the synchronization byte value.

5. The method of claim 1, wherein the data frame consists of an even field and an odd field, and wherein each field includes one data group.

6. The method of claim 5, wherein indicating an identification signal generates and indicates to the position of the synchronization byte of the corresponding enhanced data packet in each data group, the identification signal designating the insertion of the corresponding field synchronization signal.

7. The method of claim 5, wherein indicating an identification signal generates and indicates to the position of the synchronization byte of the corresponding enhanced data packet in each plurality of data groups, the identification signal designating the insertion of an even or odd field synchronization signal.

8. The method of claim 5, wherein indicating an identification signal generates and indicates to the position of the synchronization byte of the corresponding enhanced data packet for each set of 312 data packets, based upon the data frame, the identification signal designating the insertion of the corresponding field synchronization signal.

9. The method of claim 5, wherein indicating an identification signal generates and indicates to the position of the synchronization byte of the corresponding enhanced data packet for each set of 624 data packets, based upon the data frame, the identification signal designating the insertion of an even or odd field synchronization signal.

10. The method of claim 1, wherein multiplexing the enhanced data packet and a main data packet further comprises:
removing a position of a synchronization byte within the multiplexed data packet, generating information on the data packet having the identification signal indicated thereto, and
wherein inserting a field synchronization signal inserts the corresponding field synchronization signal into the data frame based upon the information of the data packet having the identification signal indicated thereto.

11. A transmitting system for processing data, the transmitting system comprising:
a group formatter for grouping a plurality of enhanced data packets, each having information included therein, thereby creating a data group;
a packet formatter for creating and indicating an identification signal in a predetermined position of at least one enhanced data packet within the data group, the identification signal designating insertion of a field synchronization signal within a data frame;
a first multiplexer for multiplexing the enhanced data packet of the data group and a main data packet, thereby creating a data frame; and
a second multiplexer for inserting a field synchronization signal within the data frame based upon the enhanced data packet having the identification signal indicated therein.

12. The transmitting system of claim 11, wherein the predetermined position of the enhanced data packet having the identification signal indicated therein corresponds to a position of a synchronization byte.

13. The transmitting system of claim 12, wherein the identification signal value is different from a synchronization byte value.

14. The transmitting system of claim 12, wherein the identification signal value is an inversed value of the synchronization byte value.

15. The transmitting system of claim 11, wherein the data frame consists of an even field and an odd field, and wherein each field includes one data group.

16. The transmitting system of claim 15, wherein the packet formatter generates and indicates the identification signal to the position of the synchronization byte of the corresponding enhanced data packet in each data group, the identification signal designating the insertion of the corresponding field synchronization signal.

17. The transmitting system of claim 15, wherein the packet formatter generates and indicates the identification signal to the position of the synchronization byte of the corresponding enhanced data packet in each plurality of data groups, the identification signal designating the insertion of an even or odd field synchronization signal.

18. The transmitting system of claim 11, wherein the first multiplexer removes a position of a synchronization byte within the multiplexed data packet, generates information on the data packet having the identification signal indicated thereto, and transmits the generated data packet information to the second multiplexer, and
wherein the second multiplexer inserts the corresponding field synchronization signal to the data frame based upon the information of the data packet having the identification signal indicated thereto.

19. A method of processing data in a receiving system, the method comprising:
tuning to a channel to receive a broadcasting data including main data and data group contained an identification signal, the identification signal including in a predetermined position of at least one enhanced data packet within the data group;
performing at least one of carrier recovery, timing recovery, and sync recovery based upon the identification signal from the tuned broadcasting data;
compensating channel distortion included in data performed at least one of carrier recovery, timing recovery, and sync recovery;
demultiplexing the channel-equalized data into main data and data group; and
performing trellis-decoding and Reed-Solomon (RS) decoding on the demultiplexed enhanced data packets within the data group.

20. The method of claim 19, wherein the identification signal designates position of a field synchronization signal within a data frame.

21. A receiving system for processing data, the receiving system comprising:
a tuner for tuning to a channel to receive a broadcasting data including main data and data group contained an identification signal, the identification signal including in a predetermined position of at least one enhanced data packet within the data group;
a demodulator for performing at least one of carrier recovery, timing recovery, and sync recovery based upon the identification signal from the tuned broadcasting data;
a channel equalizer for compensating channel distortion included in data being outputted through the demodulator;
a demultiplexer for demultiplexing the channel-equalized data into main data and data group; and
a decoder for performing trellis-decoding and Reed-Solomon (RS) decoding on the demultiplexed enhanced data packets within the data group.
